(19) United States
(12) Patent Application Publication
(10) Pub. No.: US 2009/0234706 A1
(43) Pub. Date: Sep. 17, 2009

(54) METHOD AND APPARATUS FOR SALES LEAD GENERATION

(76) Inventors: Peter Adams, Menlo Park, CA (US); Arthur Shaw, Woodside, CA (US); David Sabel, Saratoga, CA (US); Matthew Grosso, San Francisco, CA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/046,132

(22) Filed: Mar. 11, 2008

(51) Int. Cl. G06Q 10/00; G06Q 30/00

(52) U.S. Cl. 705/10; 705/37

(57) ABSTRACT

A method of auctioning contact with prospective customers. A user profile associated with a prospective customer and use of proxy information to establish a communication channel by which the prospective customer may be contacted is auctioned to a plurality of bidders and, upon receiving bids, a group of winning bidders is determined. The winning bidders purchase the use of a communication medium to contact the prospective customer using proxy information which allows the prospective customers to remain anonymous.

### FIELD OF THE INVENTION

The present invention relates to electronic commerce and more specifically to a system and method for auctioning sales leads based on dynamically created sales lead generation forms.

### BACKGROUND OF THE INVENTION

Online advertisements are generally placed as paid search advertisements or contextual advertisements on internet web pages. When consumers click on such advertisements, the advertisers are typically charged a fee according to a cost per click (CPC) pricing model. Disadvantageously, the advertisers using the CPC pricing model receive only raw data which quantifies web traffic to an advertisement but they do not receive qualified sales leads or other targeted web traffic information. Advertisers seek a solution that overcomes such shortcomings to more effectively generate qualified sales leads from advertisements placed on websites and emails.

### SUMMARY OF THE INVENTION

The present invention solves the problems of previously known online advertising revenue models such as the CPC pricing model by providing a method and apparatus for generating qualified sales leads from electronic advertisements. According to embodiments of the present invention, sales lead forms are generated for advertisers based on advertiser-specified keywords that represent the advertiser's goods and/or services. The lead forms contain dynamically generated fields. The presence of a particular field on the lead form is dictated by market forces such as the rate at which users historically complete the field and historical advertiser demand for information captured in the field.

Website publishers can embed the dynamically generated lead forms into their webpages in the same manner that advertisements from other sources, such as JavaScript advertisement tags, are currently embedded in webpages. The dynamic lead forms can also be imbedded in other electronic media such as emails, for example. Consumers then complete the fields which typically include the consumer's requirements and personal information.

In an illustrative embodiment, a consumer's non-personally identifiable information can be auctioned to interested advertisers who bid for the right to contact the consumer.

The inventive lead forms with dynamically generated fields provide high-quality leads for advertisers and provide incremental profits for publishers without affecting the publishers' display advertising programs and placements. In an illustrative embodiment of the invention, dynamic lead forms deliver only highly qualified leads to advertisers by relying on proprietary form validations. This allows advertisers to avoid wasting resources on advertisements that reach mostly unqualified website visitors. In return for such savings, advertisers and are willing to pay a higher cost per lead (CPL) for the qualified leads.

The present invention benefits consumers and online publishers as well as online advertisers. Embodiments of the invention allow consumers to quickly and safely locate desired service providers and products. The invention also enhances attracton to online content and provides online publishers with increased revenue generating opportunities.

Many other features and advantages of the present invention will become apparent from reading the following detailed description, when considered in conjunction with the drawings, in which:

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a block diagram illustrating the a system for generating sales leads according an illustrative embodiment of the present invention;

FIGS. 2 is a system block diagram illustrating an implementation of a central database according to illustrative embodiments of the present invention;

FIG. 3 is a process flow diagram illustrating a method of generating advertising revenue by placing automatically generated lead forms in online publications according to an illustrative embodiment of the present invention;

FIG. 4 is a process flow diagram illustrating a method for contacting prospective customers by purchasing proxy contact information by auction according to an illustrative embodiment of the present invention;

FIG. 5 is a process flow diagram illustrating a method of auctioning contact with prospective customers to advertisers according to an illustrative embodiment of the invention;

FIG. 6 is a process flow diagram illustrating a method for dynamically generating lead forms according to an illustrative embodiment of the invention; and

FIG. 7 is a process flow diagram illustrating a method for customer searching of advertisers according to an illustrative embodiment of the invention.

### DETAILED DESCRIPTION

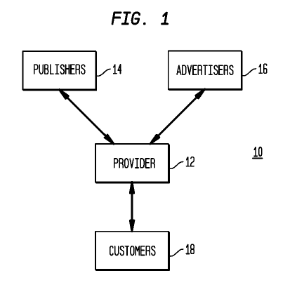

According to an illustrative embodiment of the present invention as described with reference to FIG. 1, a system 10 for generating sales leads includes a provider 12, in communication with at least one publisher 14, at least one advertiser 16 and at least one customers 18. The publisher 14 can be virtually any entity participating in electronic commerce by publishing websites or emails for example, who desires to generate revenue from advertisers 16 and/or from customers 18 as a result of customers 18 being attracted to the content of the publisher's electronic publication. The advertiser 16 is, illustratively, an entity who desires to establish sales leads that will enable communication with qualified customers 18, for example. The customers 18 can be persons or entities who are attracted to the publisher's content, and/or who seek information about goods and/or services that are offered by the advertisers.

The provider 12 provides revenue to the publishers 14, provides sales leads to the advertises 16 and provides desired information to the customers 18 by receiving, storing and processing information received from the publishers 14, advertisers 16 and customers. The provider 12 generates revenue for the publishers by generating and selling qualified sales leads to the advertisers 16. The sales leads are identified by using dynamically generated lead forms which are provided by the provider 12 to the publisher 14 to be posted in an electronic publication and filled out by interested customers 18 who view the publication.

The lead forms are dynamically generated by the provider according to advertiser-specified keywords that represent the advertiser's goods and services. Fields contained within these lead forms are dynamic. The presence of particular fields on a lead form is dictated by market forces such as the rate at which users complete such fields, and advertiser demand for the consumer information captured them. Website publishers can embed the lead forms in their webpages in the same manner that advertisements from other networks, such as JavaScript advertisement tags, are currently embedded in webpages. As the network of the present invention grows and develops over time, the lead forms can be adapted to target vertical markets and particular locations.

In an illustrative embodiments of the invention, the lead forms are customizable and can include style options and size options, for example. A website publisher can modify various aspects of a lead generation form to match the look and feel of the publisher's website. The customized lead forms can be embedded in the content pages of a website to provide an opportunity for customers to inquire and shop for desired product or service. Publishers can also use the lead forms to generate branded offers, by placing the publisher's name on the lead form, for example.

Lead forms that are intended to attract a particular consumer can be adapted to a particular website according to the website's content. For example, if the website includes an article related to finding the a broadband provider, the lead form can be shown in or around the article to offer the user an opportunity to enter their information and be notified of available deals for broadband service.

According to the present invention, publishers place keyword or contextual product-specific and/or service-specific lead qualification forms throughout their website instead of placing text advertisements or banner advertisements on their webpages. The lead forms may be placed at the end of articles, embedded in the gutters of pages, linked to form within the content, or included in email, for examples. Consumers, upon exposure to appropriately targeted lead qualification forms can enter their personal information into the dynamically generated fields of the lead forms in exchange for safe, anonymous access to qualified and motivated providers of products and services. This provides the consumer with an opportunity to inquire about good or services after reading related content on the publisher's webpage.

In an embodiment of the invention, when a consumer enters data into fields of a lead form, an algorithm validates consumer data. The algorithm effectively screens the entered data for accuracy against databases using data validation procedures. The data is used to generate leads that can then be provided to advertisers. Illustratively, the leads can be auctioned to one or more advertisers who place bids for specific types of sales leads. Thus, the present invention provides a marketplace for highly qualified leads, Both large and small business to consumer (B2C) and business to business (B2B) providers can participate in the lead auctions. The present invention is scalable in terms of both distribution channels as well as geography and can be used to takes advantage of language differences or particular sales traditions of different cultures, for example.

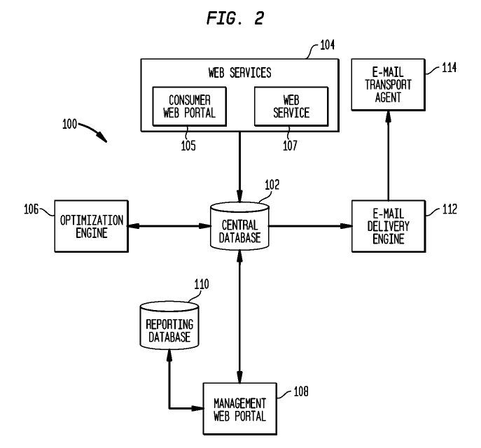

An illustrative embodiment of a system for generating sales leads according to the present invention is described with reference to FIG. 2. A sales lead generation system 100 is typically connected to a public computer network such as the Internet (not shown) and includes central database 102, a web services module 104 and a management web portal module 108. The web services module 104 incorporates a consumer web portal interface 105 and a partner web service interface 107. The central database 106 is in communication with an optimization engine 106 which processes lead statistics such as advertiser bids, form field conversion rates and probability of customers entering particular data in fields to generate revenue optimized lead forms. The management web portal module 108 allows advertisers to adjust bids and manage advertising campaigns and is in communication with a reporting database which allows advertisers to access transaction information related to their advertising campaigns. An email delivery engine 112 and email transport agent 114 are in communication with the central database 102 and facilitates email communication with customers. It should be understood that various alternative architectures can also be used to implement the system and method of the present invention.

Publishers connect to the web management portal 108 where they can generate metadata form tags for the lead generation categories that they want to include in their online publications. The publishers can choose from several different layouts and configurations of lead form. Illustratively, each form typically includes a headline or disclosure statement and some branding information.

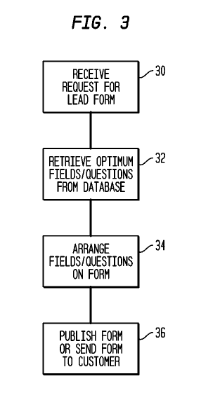

From a publisher's perspective, the present invention provides a method of generating advertising revenue by placing automatically generated lead forms in their online publications. Referring to FIG. 3, a provider receives a request for a lead form from a publisher 30. The provider retrieves optimum fields to be placed on the form from the central database 32. The publisher can optionally arrange the fields on a lead form 34. The lead form can then be published on the publisher's online publication or emailed to a customer 36.

In an illustrative embodiment, the publisher can position the form within its website or email as desired. In another embodiment, the present invention generates form tags that enable contextual placement of the most relevant form on a publisher's webpage so that the publisher can include forms globally throughout their website without having to set up individual placements. A user can fill out and submit a lead form without leaving the publisher's website. In still another embodiment, optional forms can be dynamically served to the user based on consumer targeting algorithms.

Illustratively, revenue paid by advertisers is shared between the provider and publishers as a function of traffic across the publisher's website and the quality of generated leads. The quality of generated leads can be determined by consumer ratings and by determining the number of advertisers that are utilizing the publishers as a source of leads, for example. Publishers are able to view how many leads they are generating as well as how much money they are earning by accessing an online reporting system.

Customers interact with lead qualification forms on publisher websites by entering their contact information and/or personal information in the form and identifying a preferred method of communication. The customers have incentive to provide this information in exchange for fast and secure access to providers of products and services that the user is interested in. Once the user submits their information they receive an email from the provider which is generated by email delivery engine 112. The email identifies the advertisers to whom the customer's information was sent, and may also give the customer an opportunity to correct any inaccurately entered information.

The customer's email address and optionally their personal information is stored but not passed on to the advertiser. The user is thereby provided with a method of anonymously contacting with the advertiser and reducing unwanted contact attempts from advertisers to the customer. To maintain a customer's anonymity, the system 100 issues a proxy email address or phone number to the advertiser to use when contacting the user. This provides the customer with a safe way to share contact information and prevents communication from advertisers with whom the customer no longer has an interest in corresponding. In an illustrative embodiment, to increase customer confidence, the customers are also presented with information describing how their email address will be used.

Advertisers then contact the customer via the customer's preferred contact method. Typically, if a preferred contact method is not indicated, advertisers can send an email to the customer's proxy email address by default. Customers can then choose whether or not to respond directly to an advertiser. In an illustrative embodiment, once contact between a customer and an advertiser has been established, the customer is prompted to rate their experience with the advertiser. This rating is used to build a reputation for the advertiser and can be used to ban advertisers and/or to help customers choose between various advertisers, for example. Optionally, customers can request that their information be sent to more advertisers if they did not like the outcome of a contact established with a first advertiser.

In an embodiment of the invention, customers may also obtain proxy email addresses and phone numbers from system 100 and provide the proxy information to third parties to avoid disclosing their actual email or phone numbers to the third parties. Customers may then manage these proxies through consumer web portal interface 105. The consumer web portal interface 105 allows the customers to terminate proxy information thereby ending future emails or calls from the third parties. In this embodiment the customer can remain anonymous and maintain control over his/her ability to be contacted while allowing participating in events that require disclosure of a phone number or email address.

Typically, embodiments of the invention match customers to multiple providers of products or services. Advertisers can customize the content of their messages to customers or direct inquiries to their websites, email, or call centers based on keyword and user profile information provided by the inventive system 100.

Illustratively, advertisers can interact with system 100 by participating in auctions conducted by the provider for access to customers' anonymous lead data. Upon winning an auction, advertisers may access the customer's anonymous lead data in real time an interface that system 100 provides to the advertisers.

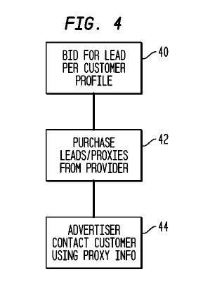

When a lead form generates a lead, the system 100 of the present invention determines which advertiser will receive the lead by conducting an auction among those advertisers who have budgets available and have active bids for leads of a specific category. Referring to FIG. 4, advertisers place bids 40 for leads corresponding to particular customer profiles. The leads can then be purchased 42, by auction for example, as proxies from the provider. Advertisers having purchasing the leads or having winning auction bids can then contact the interested customers 44 using the proxy contact information.

Typically the auction is administered as a second price auction in which each advertiser's maximum bid is used to determine the winners but wherein each of the winners are only required to pay the amount of the highest losing bid. More than one advertiser may be deemed a winner of the auction, but the number of winners is typically limited to between 3 and 5 advertisers. The use of second price auctions provides an incentive for advertisers to provide their true maximum bid per lead with knowledge that they will not pay more than the minimum needed to be a winner in the auction.

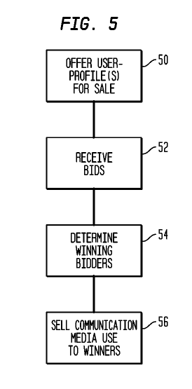

From the provider's perspective, an embodiment of the present invention includes a method of auctioning contact with prospective customers. The method is described with reference to FIG. 5 and includes the steps of offering for sale over a computer network to a plurality of bidders (i.e., advertisers), a user profile associated with a prospective customer and use of a communication medium by which the prospective customer may be contacted. The provider receives bids 52 and determines one or more winning bidders 54. In this embodiment, the provider then sells the use of a communication medium to the winning bidders 56. In an embodiment, all bids are kept private and a limit is placed on the maximum number of advertisers allowed to receive a single lead. Optionally, minimum bids per lead category can also be implemented. Illustratively, advertisers can be allowed to limit their bids to leads from customers within a specific geographical area (either by zip code, area code or location radius) or by other attributes present in the lead form.

A web-based management interface is provided to advertisers which allows the advertisers to set or change their bids at will, to increase or decrease their bidding budgets, and to block leads that do not meet the advertiser's quality standards. In an embodiment of the invention, quality standards can be implemented rating leads as a function of customer age or income level, for example.

The invention provides a self service advertising campaign management system where the advertiser can set up lead campaigns, set budgets, and view statistics using the management interface. Targeting profiles can be set by advertisers for each advertisement campaign, so that advertisers can precisely tailor bids for various categories of leads.

In an embodiment of the invention, the management interface allows advertisers to target specific user profiles via a multi-step process performed by the advertiser. First, the advertiser chooses a keyword to apply to the lead. Next, the advertiser selects optional fields for targeting leads, such as age, income, geographical location, gender, credit card type, etc. Hundreds of fields can be presented to the advertiser to choose from. The most popular or successful fields may also be suggested by the provider to the advertiser. As a third step, the selected optional fields are grouped into desired user profiles. Examples of desired user profiles include, high income credit card holders, young males, low-interest credit card holders, senior citizens etc. As a final step, the advertiser identifies a bid amount to be placed in auctions for leads corresponding to the designated profiles.

Leads that are presented to the advertiser can be stored and viewed in the campaign management system and individual lead detail and interactions are viewable by the advertiser. The advertiser is thereby presented with feedback which can assist the advertiser in generating future advertising campaigns.

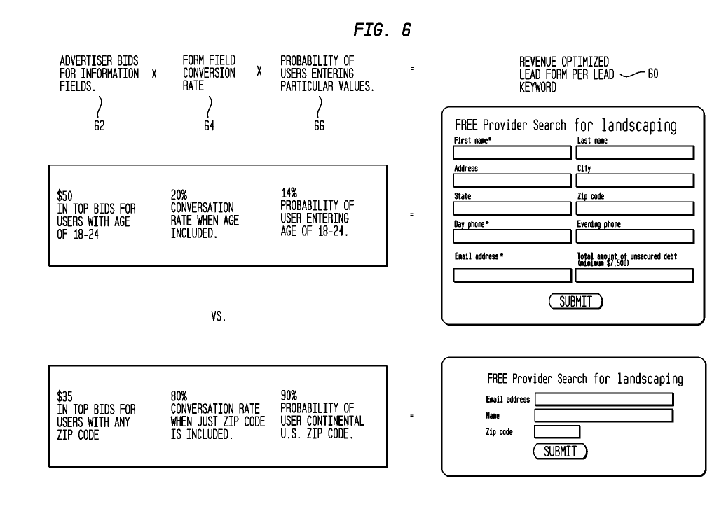

The process of dynamically generating lead forms according to an illustrative embodiment of the invention is described with reference to FIG. 6. Dynamic lead forms are generated as a function of both advertiser demand for customer information, and the customer's willingness to disclose that information. The revenue optimized lead form per lead keyword 60 is the result of advertisers' bids for specific information fields 62 multiplied by a form field conversion rate 64 multiplied by a probability of a customer entering a particular value 66 in the field. For example, the revenue optimized lead form may include a top bid of $50 for customers in the age bracket of 18-24 years, multiplied by 20 percent conversation rate when age is included by a customer in a lead form, multiplied by 14% probability of a customer falling into the age bracket of 18-24 years.

In another example depicted in FIG. 6, the revenue optimized lead form may include a top bid of $35 for users associated with a particular zip code multiplied by an 80% conversation rate when the zip code is provided by the customer, multiplied by the 90% chance that the customer enters a continental USA zip code.

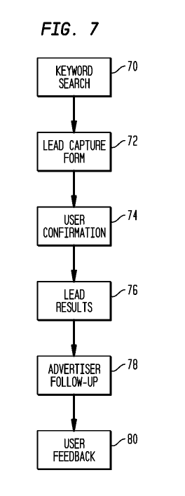

In another embodiment of the invention described with reference to FIG. 7, a customer may initiate a search for advertisers who provides desired goods or services. A customer searches for an advertiser by entering a keyword in a search box at step 70. If no advertisers are associated with the entered keyword, the user is shown related keywords that are associated with advertisers. Next, a lead capture form is generated dynamically at step 72, based on advertiser bids for the search term and historical consumer response rates to form fields. Illustratively, the customer's email address and zip code are required on the lead capture form. Optionally, at step 74, the customer confirms his or her email address. A repeat user may skip this confirmation step if the user is recognized by reading a cookie stored on his or her computer, for example. Lead results are generated at step 76 and an auction, is conducted among bidding advertisers. Winning advertisers are then charged for the lead and provided with the users proxy email and/or proxy phone number to contact the user. Next, at step 78, advertisers contact the user through the networks proxy email interface or proxy phone number.

Emails that are sent to the customer may follow templates or be custom written, depending on advertiser preference. Customers may then review the advertisers communication and choose whether or not to respond to the advertiser's call. Next, at step 80, after a predetermined period of time, the user is prompted to rate the advertisers. This rating information is made available to subsequent users.

The system of the present invention may establish a predetermined number of follow-up messages which the advertiser may send to the user over a predetermined period of time. For example, an advertiser may be allowed two contact attempts over a 30 day period. Advertisers can create as many email templates as they desire and target them to specific user profiles, or create a custom response for each lead.

Although the various embodiments of the present invention are described herein with reference to one or more providers, customers, advertisers, and publishers, persons having ordinary skill in the art should understand that these terms are used herein for consistency and are not limiting. For example, the terms ‘customers’, ‘prospective customers’ and ‘users’ are interchangeable and could mean any number of interested parties who may input information into the lead forms and/or who may be contacted by ‘advertisers.’ Similarly, the term ‘provider’ is not limited to any particular type of service provider, but simply identifies a party who facilitates a transaction according to the present invention, such as an auction and/or lead form generation.

The foregoing description is to be considered illustrative and not limiting. It is to be understood that numerous modifications can be made to the various embodiments of the present invention described herein without departing from the spirit thereof.

1. A method of providing sales leads, comprising:
offering for sale over a computer network to a plurality of bidders proxy information by which a prospective customer may be contacted, said offering including providing a customer profile associated with the prospective customer;
receiving bids from bidders of the plurality of bidders;
determining winning bidders from the received bids; and
selling the proxy information to the winning bidders at a price determined by the received bids.

2. The method of claim 1, wherein bidders of the plurality of bidders comprise advertisers who are required to indicate a maximum price, and are selected as winning bidders if the indicated maximum price is above a predetermined amount.

3. The method of claim 1, wherein the user profile comprises a proxy email address associated with an actual email address for the prospective customer, and wherein the actual email address is concealed from the winning bidders.

4. The method of claim 1, further comprising receiving the user profile from a publisher and distributing a portion of the price to the publisher.

5. The method of claim 4, further comprising reporting to the publisher an indication of revenue earned by the publisher through potential customers' completion of leads forms on the publisher's web site.

6. The method of claim 1, wherein a number of winning bidders for a user profile is based on at least one selected from the group consisting of the price, number received bids, and budgets of advertisers for a particular lead category.

7. The method of claim 1, wherein the customer profile is associated with at least one selected from the group consisting of keywords and categories.

8. The method of claim 1, wherein the customer profile is associated with a customer matching at least one qualification specified by a bidder in the first plurality of bidders.

9. A system for auctioning to advertisers contact with prospective customers, comprising:
a first interface including a first communication medium that enables advertisers to participate in an auction proxy information by which a prospective customer may be contacted, wherein an offering in said auction includes a customer profile associated with the prospective customer;
a second interface including a second communication medium that enables publishers to display lead forms that capture the customer profiles; and
a database storing the customer profiles, bidding budget information for the advertisers, and revenue information for the publishers.

10. The system of claim 9, wherein the first interface allows an advertiser to bid for customer profiles based on criteria provided by the advertiser.

11. The system of claim 9, wherein the second interface provides revenue reports to the publishers.

12. The system of claim 9, wherein the first interface facilitates the sale of a customer profile associated with a prospective customer and a use of communication medium by which the prospective customer may be contacted by at least one bidding advertiser after an auction.

13. The system of claim 9, wherein the first interface facilitates the sale of a customer profile associated with a prospective customer and proxy information by which the prospective customer may be contacted by at least one bidding advertisers after an auction, wherein the at least one bidding advertisers are not.

14. A method of marketing comprising:
placing a bid by a bidder to purchase proxy information by which the prospective customer may be contacted wherein the prospective customer is characterized according to a customer profile;
purchasing by the bidder proxy information by which the prospective customer may be contacted by the bidder being designated as a winner of the auction;
contacting the prospective customer by the winner a first time via a proxy, the proxy email address or interface assigned to the prospective customer by a provider conducting said auction; and
subsequently contacting the prospective customer via the proxy email address after a predetermined period of time.

15. The method of claim 14, wherein the bids are placed for desired customer profiles according to criteria provided by the bidder.

16. A computer readable medium, containing instructions which, when executed by a computer, auctions use of proxy information by which the prospective customer may be contacted by:
offering for sale over a computer network to a plurality of bidders use of the proxy information by which the prospective customer may be contacted, said offering including providing a customer profile associated with the prospective customer;
receiving bids from bidders in the plurality of bidders;
determining winning bidders from the received bids; and
selling the use of the proxy information to the winning bidders at a price determined by the received bids.

17. A computer readable medium, containing instructions which, when executed by a computer, markets at least one of the group consisting of goods and services to a user, by:
placing a bid by a bidder to purchase use of proxy information by which the prospective customer may be contacted during an auction, the prospective customer being described according to a customer profile;
purchasing by the bidder use of the proxy information by which the prospective customer may be contacted upon the bidder being designated as a winner of the auction;
contacting the prospective customer by the winner a first time via a proxy, the proxy email address or interface assigned to the prospective customer by a provider conducting said auction; and
subsequently contacting the prospective customer via the proxy email address after a predetermined period of time.

18. A method of generating sales leads, comprising:
receiving from a potential customer a request for an electronic form, the request received over a computer network;
retrieving from a database, in response to the request, a plurality of questions, the plurality of questions determined by advertiser demand for answers to questions in the plurality, the advertiser demand expressed in at least one of the group consisting of a number of bids for the answers and bid amount for the answers;
arranging the retrieved questions on the electronic form; and
sending the electronic form to the potential customer over a computer network.

19. The method of claim 18, wherein the bid comprises a bid for a consumer lead belonging to a particular category of goods and services.

20. The method of claim 18, wherein the bid is contingent on the potential customer being located in a specified geographical location.

21. The method of claim 18, wherein the bid is contingent on how questions on the form are answered by the potential customer.

22. The method of claim 18, wherein retrieving the plurality of questions comprises retrieving questions associated with a probability that the potential customer will answer the question.

23. The method of claim 22, wherein the probability is calculated by inspecting forms completed by other potential customers for answers supplied to questions in the plurality.

24. The method of claim 23, wherein the probability is weighted by bid amount for the answers.

25. A system for providing sales leads, comprising:
a provider in communication with at least one customer and at least one publisher; and;
a lead form automatically generated by the provider, said lead form including a plurality of fields for receiving input from the customer(s), wherein the fields are automatically included in the lead form as a function of field value statistics computed by the provider(s), said lead form further including optional style elements selectable by the provider(s).

26. The system of claim 25, comprising:
means for automatically imbedding said lead form in electronic publications of the publisher(s).

27. The system of claim 25. wherein said field value statistics are selected from the group consisting of a rate at which a field have been completed by the customer(s) and advertiser demand for the field.

28. The system of claim 25, comprising:
at least one advertiser in communication with said provider;
means for identifying qualified customer(s) as a function of the input; and
means for auctioning access, by the provider(s) to the advertiser(s), to said qualified customer(s)

29. The system of claim 28 wherein said access comprise proxy contact information.

30. The system of claim 28 comprising:
means for sharing revenue from said auctions between the provider(s) and the publisher(s).

31. An online lead form, comprising:
a plurality of fields for receiving input from customer(s), wherein the fields are automatically included in the lead form as a function of field value statistics computed by one or more providers, said lead form further including optional style elements selectable by the provider(s).
